(19) United States
(12) Patent Application Publication
(10) Pub. No.: US 2010/0051772 A1
(43) Pub. Date: Mar. 4, 2010

(54) PROJECTOR INSTALLATION APPARATUS

(75) Inventors: Isao Sakamaki, Kashiwa-shi (JP); Naoya Nishimura, Matsumoto-shi (JP); Saeko Inoue, Matsumoto-shi (JP); Genta Kawabe, Matsumoto-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/545,141

(22) Filed: Aug. 21, 2009

(30) Foreign Application Priority Data
Sep. 1, 2008 (JP) 2008-223203

(51) Int. Cl. A47B 96/06; F16D 3/50

(52) U.S. Cl. 248/309.1; 403/164

(57) ABSTRACT

An installation apparatus configured to install a projector includes: a first supporting unit having a member to be placed on an object used for installation; a second supporting unit extending downward of the object from the first supporting unit and supporting the projector under the object; and a connecting portion having a plurality of connectors configured to connect the projector arranged therein.

### CROSS-REFERENCE

The present application claims priority from Japanese Patent Application No. 2008-223203 filed on Sep. 1, 2008, which is hereby incorporated by reference in its entirety.

### BACKGROUND

A projector is a projecting display apparatus which is able to project an image and display in an enlarged scale, and is used generally in business scenes. In the related art, such a projector is used in a form of being installed on a desk in a conference room, for example. However, when the projector is installed in such a manner, it may hinder the work to be done on the desk. Therefore, there is a demand for the improvement of this point in the related art. For example, in the Japanese Patent Publication No. 2004-252049, a technology to mount a projector installation instrument on a side end of an upper face board of a conference desk close to a projecting surface and demountably mount a front projecting-type projector via the projector installation instrument is disclosed.

Japanese Patent Publication No. 2004-252049 and Japanese Patent Publication No. 2-285882 are examples of related art.

In this technology, in order to mount the projector installation instrument at the side end of the upper face board of the conference desk, an additional area is needed at the side end. Also, sufficient devise is not made as regards the convenience when the projector is used.

### SUMMARY

Various embodiment may provide a projector installation apparatus which improves the convenience when a projector is used.

According to at least one embodiment of the disclosure, there is provided an installation apparatus configured to install a projector including: a first supporting unit having a member to be placed on an object used for installation; a second supporting unit extending downward of the object from the first supporting unit and supporting the projector under the object; and a connecting portion having a plurality of connectors configured to connect the projector arranged therein.

In this configuration, since the projector is supported under the object used for installation, spaces on an upper surface or a side surface of the object used for installation can be effectively utilized. Consequently, improvement of the convenience when the projector is used is achieved. Also, since the plurality of connectors are arranged in the connecting portion, the connection of the projector is smoothly achieved. Consequently, improvement of the convenience when the projector is used is achieved.

Also, by rotating a first movable member, vertical adjustment of the position to display a projector projecting screen is achieved. Consequently, improvement of the convenience when the projector is used is achieved.

Also, by the provision of a second movable member, the upper surface and the side surface of the projector can be directed to a position where the user can operate conveniently. Therefore, the user is able to operate (for example, is able to replace a component of the projector) while the projector is installed in the installation apparatus. Consequently, improvement of the convenience when the projector is used is achieved.

Also, mounting and fixation of the installation apparatus are achieved easily. Consequently, improvement of the convenience when the projector is used is achieved.

Also, the projector and a peripheral apparatus of a projector support equipment can be integrated for use. Consequently, improvement of the convenience when the projector is used is achieved.

Also, various types of the projector support equipment can be used adequately according to the application of usage of the projector. Consequently, improvement of the convenience when the projector is used is achieved.

The disclosure may be realized in various embodiments. For example, the embodiment may be realized in the form of a projector installation apparatus and method, a projection display system provided with the projector installation apparatus, a computer program for realizing functions of the method or the apparatus, and a recording medium in which the computer program is recorded.

### BRIEF DESCRIPTION OF THE DRAWINGS

Non-limiting and non-exhaustive embodiments of the present disclosure will be described with reference to the accompanying drawings, wherein like reference numbers reference like elements.

FIG. 1 is an explanatory drawing showing a schematic configuration of an installation apparatus configured to install a projector according to an embodiment of the disclosure.

FIG. 2 is an explanatory drawing showing a schematic configuration of an installation apparatus according to a second embodiment.

FIG. 3 is an explanatory drawing showing a schematic configuration of an installation apparatus according to a third embodiment.

FIG. 4 is a schematic explanatory drawing showing a state in which a first movable member is rotated.

FIG. 5 is an explanatory drawing showing a schematic configuration of an installation apparatus according to a fourth embodiment.

FIGS. 6A and 6B are explanatory drawings showing a schematic configuration of a bottom surface moving mechanism.

FIG. 7 is an explanatory drawing showing a case in which the bottom surface moving mechanism is used.

FIG. 8 is an explanatory drawing showing a schematic configuration of an installation apparatus according to a fifth embodiment.

FIG. 9 is an explanatory drawing showing a schematic configuration when the installation apparatus is switched to a fixed state.

FIG. 10 is an explanatory drawing showing a schematic configuration of an installation apparatus according to a sixth embodiment.

FIG. 11 is an explanatory drawing showing a state in which a second supporting unit is slid by a sliding mechanism.

FIG. 12 is an explanatory drawing showing a schematic configuration of an upper surface of a second upper surface member.

FIG. 13 is an explanatory drawing showing a schematic configuration of an installation apparatus according to a seventh embodiment.

FIG. 14 is an explanatory drawing showing a schematic configuration of an installation apparatus according to an eighth embodiment.

FIG. 15 is an explanatory drawing showing a schematic configuration of an installation apparatus according to a ninth embodiment.

FIGS. 16A, 16B, and 16C are explanatory drawings showing a schematic configuration of a rotating mechanism.

FIG. 17 is an explanatory drawing showing a state in which a second supporting unit is rotated by the rotating mechanism.

FIG. 18 is an explanatory drawing showing a schematic configuration of an installation apparatus according to a tenth embodiment.

FIG. 19 is an explanatory drawing showing a schematic configuration of an installation apparatus according to an eleventh embodiment.

FIG. 20 is an explanatory drawing showing a schematic configuration of an installation apparatus and an installation apparatus according to a twelfth embodiment.

FIG. 21 is a block diagram showing a schematic configuration of the installation apparatus and the installation apparatus according to the twelfth embodiment.

FIG. 22 is an explanatory drawing showing an example of a screen of an application executed by a computer.

FIG. 23 is an explanatory drawing showing a schematic configuration of an installation apparatus according to a thirteenth embodiment.

FIG. 24 is an explanatory drawing showing a schematic configuration of a projector support equipment.

FIG. 25 is a block diagram showing a function of the projector support equipment.

FIGS. 26A to 26D are explanatory drawings showing states of conferences using the installation apparatus.

FIG. 27 is a block diagram showing a function of various types of projector support equipment which are applicable to the thirteenth embodiment.

### DESCRIPTION OF EMBODIMENTS

Subsequently, embodiments of the disclosure will be described on the basis of examples in the following sequence.
A. First to Thirteenth Embodiments
B. Modifications

### A. First to Thirteenth Embodiments

### A1. First Embodiment

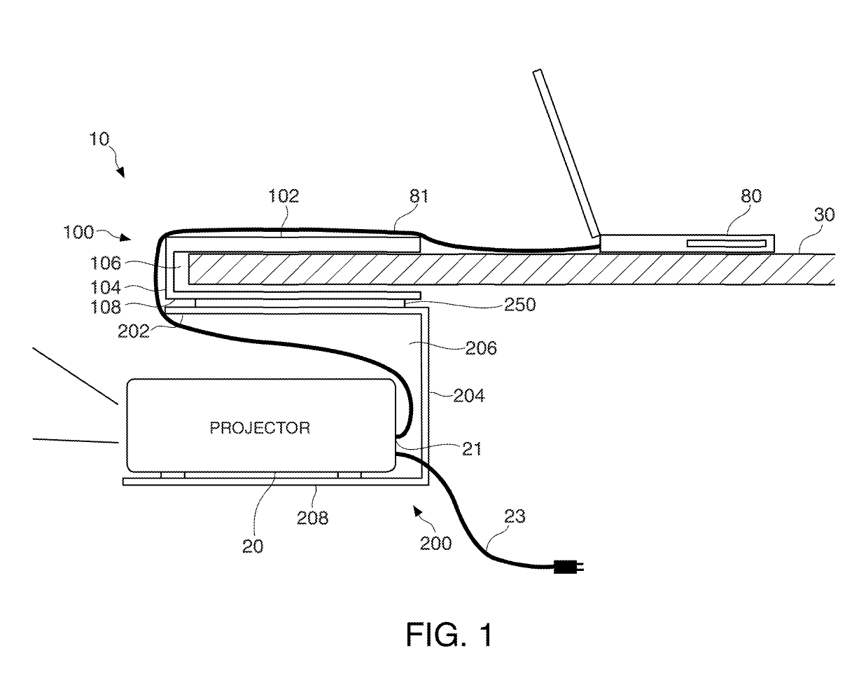

FIG. 1 is an explanatory drawing showing a schematic configuration of an installation apparatus configured to install a projector according to an embodiment of the disclosure. An installation apparatus 10 includes a first supporting unit 100 and a second supporting unit 200. The first supporting unit 100 includes a first upper surface member 102, a front portion 104, a first hollow portion 106, and a first bottom surface member 108. The first upper surface member 102 is a panel-shaped member to be placed on a desk 30. The front portion 104 is a panel-shaped member extending downward from one end of the first upper surface member 102 on the side of the end surface of the desk 30 in the direction of about 90 degrees. The first bottom surface member 108 is a panel-shaped member arranged from one end of the front portion 104 on the lower side in substantially parallel to the first upper surface member 102. The first hollow portion 106 is a space formed inside the first supporting unit 100. As shown in FIG. 1, the installation apparatus 10 is installed on the desk 30 by inserting the desk 30 into the first hollow portion 106.

The second supporting unit 200 includes a connecting portion 250, a second upper surface member 202, a back surface member 204, a second hollow portion 206, and a second bottom surface member 208. The connecting portion 250 is a member for connecting the first bottom surface member 108 and the second upper surface member 202. The first supporting unit 100 and the second supporting unit 200 are connected by the connecting portion 250. The connecting portion 250 may be of any given device and, for example, an adhesive agent, a screw, a bolt, and so on may be used. It is also possible to configure the first bottom surface member 108, the connecting portion 250, and the second upper surface member 202 as one single member. In this configuration, since the number of components may be reduced, so that the cost may be preferably reduced. The second upper surface member 202 is a panel-shaped member to be arranged substantially in parallel to the first bottom surface member 108. The back surface member 204 is a panel-shaped member extending downward from one end of the second upper surface member 202 on the opposite side of the end surface of the desk 30 in the direction of about 90 degrees. The second bottom surface member 208 is a panel-shaped member arranged from one end of the back surface member 204 on the lower side in substantially parallel to the second upper surface member 202. The second hollow portion 206 is a space formed inside the second supporting unit 200. The cross-section at the center of the installation apparatus 10 formed as described above assumes a substantially S-shape. A projector 20 is remained in the second hollow portion 206. When a computer 80 and the projector 20 are connected, an external monitor output connector 82 of the computer 80 is inserted into an IF unit 21 of the projector 20. This method is the same as the case where the projector 20 is installed on the desk in the related art. A power source supply to the projector 20 is achieved by inserting a power source plug 23 into a power source wall socket.

In this manner, in the first embodiment, the second hollow portion 206 is formed under the desk. Then, since the projector is held in the second hollow portion 206, the spaces on the upper surface and the side surface of the desk can effectively be used. Consequently, improvement of the convenience when the projector is used is achieved.

### A2. Second Embodiment

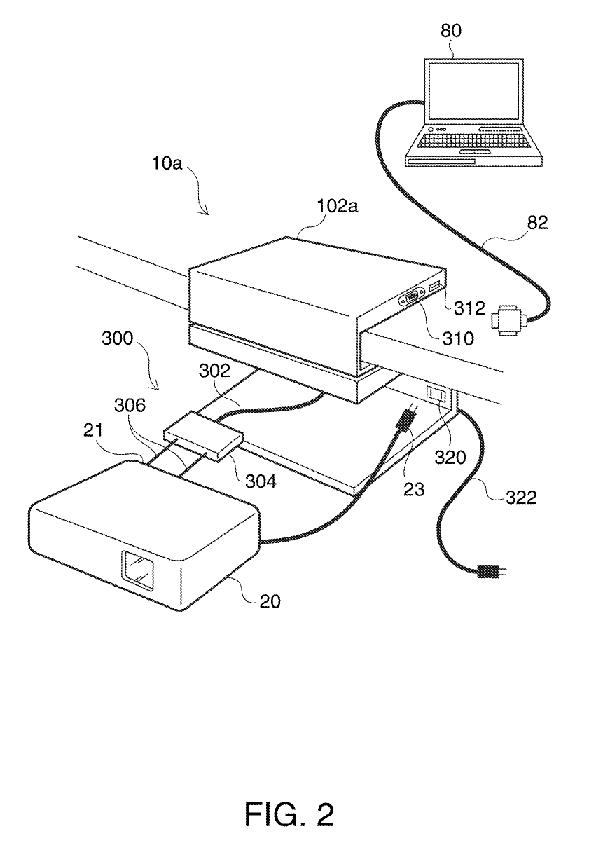

FIG. 2 is an explanatory drawing showing a schematic configuration of an installation apparatus 10a according to a second embodiment. It has the same configuration as the installation apparatus 10 in the first embodiment except that a wiring connecting mechanism 300 is provided. The wiring connecting mechanism 300 includes a group of cable 302, a terminal box 304, a connector 306, an RGB input interface 310, a USB interface 312, a power source socket 320, and a power source cable 322.

The RGB input interface 310 is a connecting port for connecting the external monitor output connector 82 of the computer 80. In the same manner, the USB interface 312 is a connecting port configured to connect the USB connector of the computer 80. These connecting ports (the RGB input interface 310 and the USB interface 312) are provided on the side surface of a first upper surface member 102a. The group of cable 302 is a cable including cables extending from the RGB input interface 310 and the USB interface 312 bundled into one cable. The group of cable 302 passes through the interior of the first supporting unit 100, and is exposed to the outside from the back surface member 204 of the second supporting unit 200. Then, the group of cable 302 is separated again via the terminal box 304. The terminal box 304 includes a connecting port for connecting the projector 20. The connectors 306 are connectors for connecting the terminal box 304 and the IF unit 21 of the projector 20. The group of cable 302, the terminal box 304, and the connectors 306 serve as a connecting unit. In this embodiment, although the apparatus which supplies images to the projector 20 is described as the computer 80, the image supplying apparatus may be of any given electronic instruments. An external storage medium may be connected directly to the USB interface 312. The power source socket 320 is an insertion port for allowing insertion of the power source plug 23 of the projector 20. In order to enable the power source supply from the power source socket 320, the power source cable 322 extending from the back surface member 204 is inserted into the power source wall socket. Accordingly, installation is easily achieved in comparison with the case of inserting the power source plug 23 of the projector 20 directly into the power source wall socket.

In this manner, with the configuration in which a connecting mechanism is provided on the installation apparatus, the connection between the computer and the projector is achieved without leading the cable of the computer into the IF unit of the projector. Consequently, smooth connection of the projector is enabled, and improvement of convenience when the projector is used is achieved.

### A3. Third Embodiment

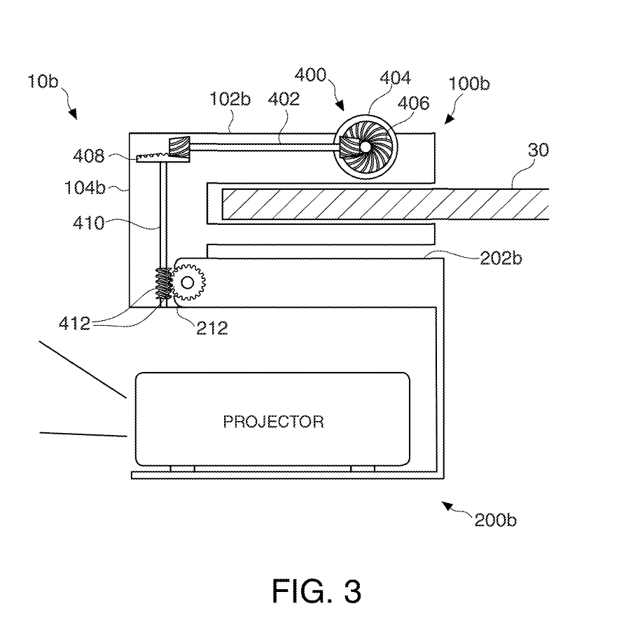

FIG. 3 is an explanatory drawing showing a schematic configuration of an installation apparatus 10b according to a third embodiment. FIG. 3 is a cross-sectional view of the installation apparatus 10b. It has substantially the same configuration as the installation apparatus 10 in the first embodiment and is mainly different therefrom in that an angle adjusting mechanism 400 which functions as a rotatable first movable member is provided and the connecting portion 250 is not provided. The angle adjusting mechanism 400 includes a first shaft 402, a cover 404, a first gear 406, a second gear 408, a second shaft 410, and a worm gear 412.

The angle adjusting mechanism 400 is arranged in the interior of a first supporting unit 100b and a second supporting unit 200b so as to connect the same. The first gear 406 may be, for example, a bevel gear. The cover 404 is mounted so as to surround the same, and is partly exposed to the outside of a first upper surface member 102b. The first gear 406 meshes with the bevel gear positioned at one end of the first shaft 402. The first shaft 402 is provided with bevel gears at both ends thereof. The bevel gear at the other end of the first shaft 402 meshes with the second gear 408. The second gear 408 includes the second shaft 410 extending downward from the center thereof. The lower end of the second shaft 410 is formed with a worm of the worm gear 412. A worm wheel which corresponds to the worm is provided on a second upper surface member 202b. In order to prevent contact when the worm wheel is rotated, the second upper surface member 202b is provided with a chamfered portion 212.

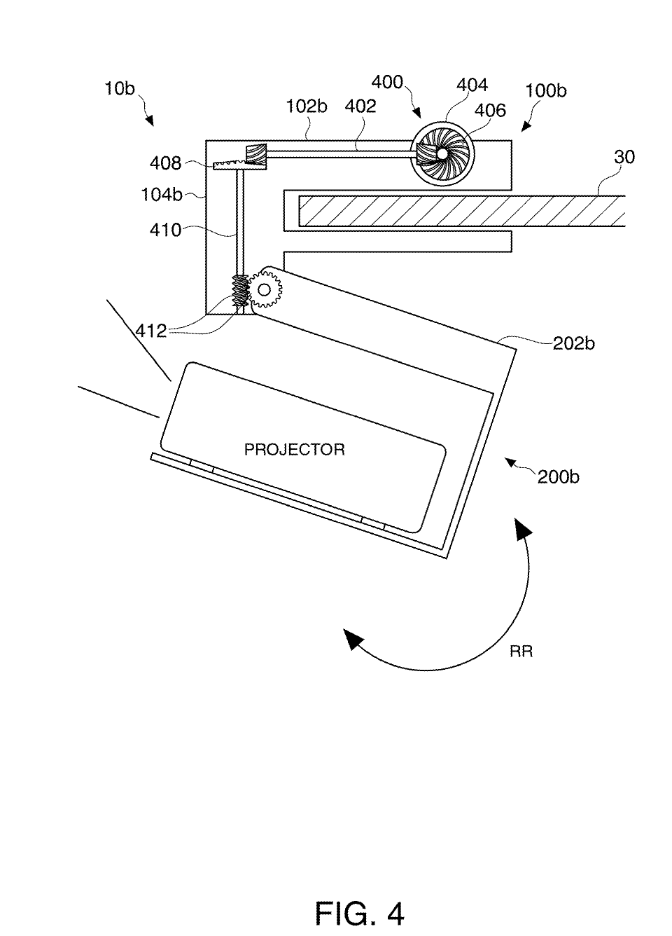

FIG. 4 is a schematic explanatory drawing showing a state in which the first movable member is rotated. First of all, a user rotates the first gear 406 via the cover 404. The rotation is transmitted to the worm gear 412 via the first shaft 402, the second gear 408, and the second shaft 410. Accordingly, the second supporting unit 200b can be rotated in an RR direction about the center of the worm wheel. When the second supporting unit 200b is rotated in the RR direction, the position of display of a projected screen from the projector 20 supported by the second supporting unit 200b is moved in the vertical direction correspondingly. Although the angle adjusting mechanism 400 is configured to be operated manually by the user in this embodiment, it may be configured to be operated electrically with a motor or the like.

In this manner, with the configuration having the angle adjusting mechanism in the installation apparatus, the vertical adjustment of the display position of a projector projecting screen is achieved with a simple operation on the desk. Consequently, improvement of the convenience when the projector is used is achieved.

### A4: Fourth Embodiment

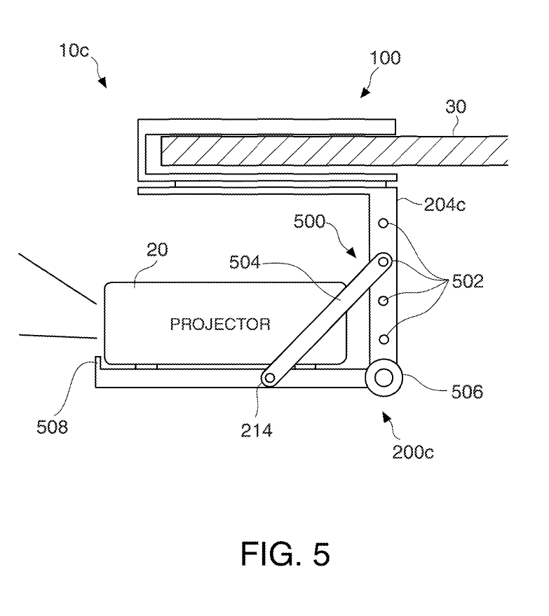

FIG. 5 is an explanatory drawing showing a schematic configuration of an installation apparatus 10c according to a fourth embodiment. It has substantially the same configuration as the installation apparatus 10 in the first embodiment and is mainly different therefrom in that a bottom surface moving mechanism 500 which functions as a second movable member is provided.

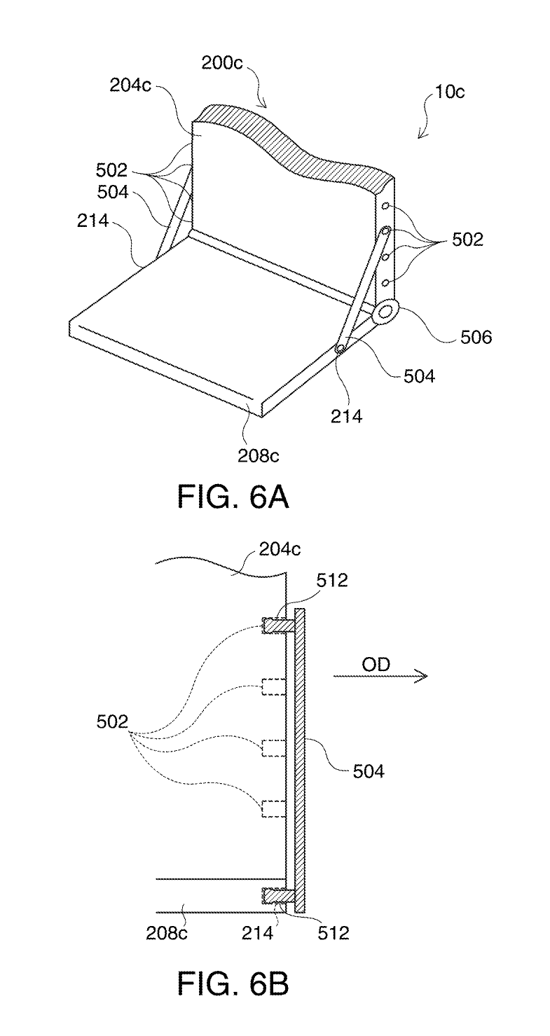

FIGS. 6A and 6B are explanatory drawings showing a schematic configuration of the bottom surface moving mechanism 500. The bottom surface moving mechanism 500 includes adjusting holes 502, an engaging member 504, a hinge 506, and a stopper 508. FIG. 6A is a perspective view showing a part of the installation apparatus 10c. An upper side surface portion (the second upper surface member 202 and a back surface member 204c) extending from the first supporting unit 100 to a second bottom surface member 208c and the second bottom surface member 208c are connected with the intermediary of the hinge 506. Also, the back surface member 204c and the second bottom surface member 208c are fixed by the engaging members 504. The both side surfaces of the back surface member 204c are formed with the adjusting holes 502 for fixing upper ends of the engaging members 504. The plurality of adjusting holes 502 are preferably formed at a regular pitch. Locking holes 214 for fixing lower ends of the engaging members 504 are provided on both side surfaces of the second bottom surface member 208c. FIG. 6B is a partially cross-sectional view of the installation apparatus 10c. Engaging ends 512 are provided at an upper end and a lower end of the each engaging member 504. In order to allow the movement of the second bottom surface member 208c, the engaging ends 512 are pulled in an outward direction OD to pull out the engaging ends 512 from the adjusting holes 502. Subsequently, the second bottom surface member 208c is moved to a desired position and the engaging ends 512 are inserted into the adjusting holes 502 again.

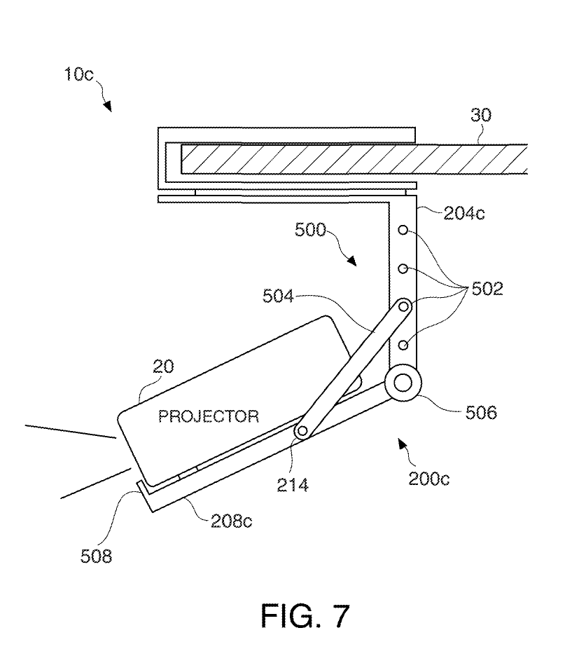

FIG. 7 is an explanatory drawing showing a case in which the bottom surface moving mechanism 500 is used. As shown in the drawing, by changing the position of the adjusting holes 502 where the engaging ends 512 are inserted, the angle at which the second bottom surface member 208c are fixed can be adjusted. In order to prevent the projector 20 from dropping off, the stopper 508 is provided. Although the bottom surface moving mechanism 500 is configured to be adjusted manually by the user in this embodiment, it may be configured to be adjusted electrically with a motor or the like.

In this manner, with the configuration having the bottom surface moving mechanism in the installation apparatus, the upper surface and the side surface of the projector can be directed to a position where the user can operate conveniently with a simple operation. Therefore, the user is able to operate (for example, is able to replace a component of the projector) while the projector is installed in the installation apparatus. Consequently, improvement of the convenience when the projector is used is achieved.

### A5. Fifth Embodiment

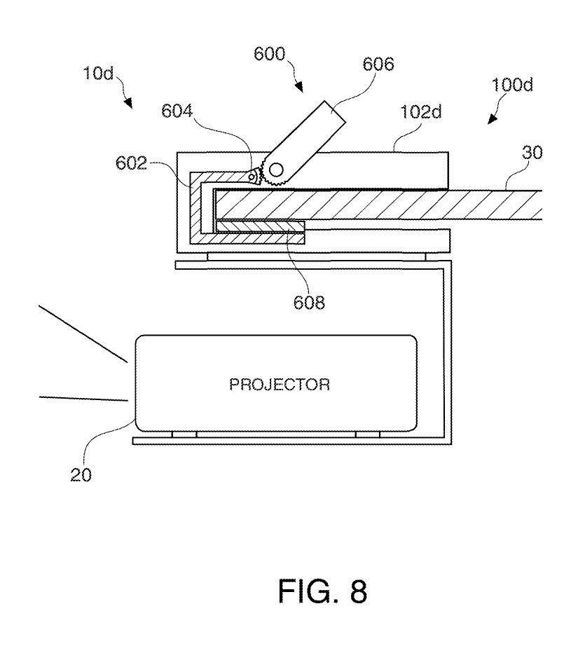

FIG. 8 is an explanatory drawing showing a schematic configuration of an installation apparatus 10d according to a firth embodiment. FIG. 8 is a cross-sectional view of the installation apparatus 10d. It has substantially the same configuration as the installation apparatus 10 in the first embodiment and is mainly different therefrom in that a clamping mechanism 600 which functions as a switching unit is provided. The clamping mechanism 600 includes a holding member 602, a gear 604, a lever 606, and a non-slip member 608.

The holding member 602 of the clamping mechanism 600 is a member having an angular C-shape whose lower side is longer than the upper side. The gear 604 is provided on the upper end side of the holding member 602. The gear 604 is fixed to a first upper surface member 102d at a supporting point PP. A portion where the gear 604 comes into contact with the lever 606 is formed to have teeth. In the same manner, a portion of the lower end of the lever 606 which comes into contact with the gear 604 is also formed to have teeth. In addition, the lever 606 is fixed to the first upper surface member 102d at a lower center portion thereof.

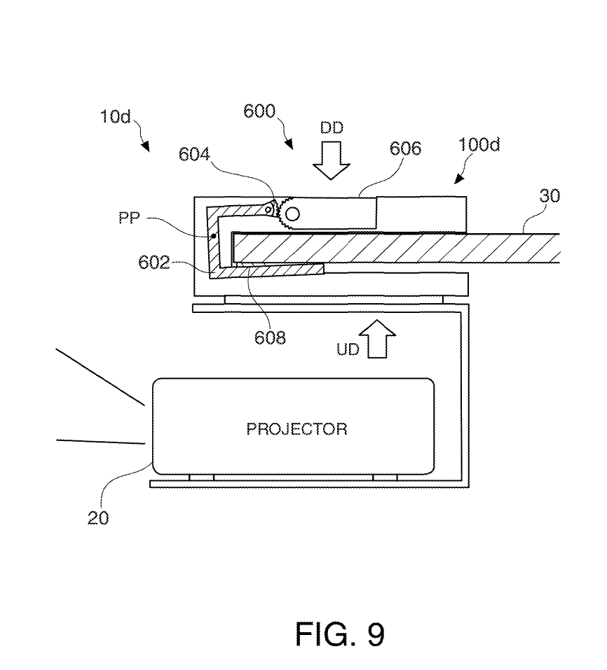

FIG. 9 is an explanatory drawing showing a schematic configuration when the installation apparatus 10d is switched to a fixed state. The user presses the lever 606 in a downward direction DD. A force applied to the lever 606 is transmitted to the holding member 602 via the gear 604. The holding member 602 is pressed at the lower side in an upward direction UD about the supporting point PP by the principle for leverage. Consequently, the installation apparatus 10d is brought into the fixed state which is a state of being fixed to the desk 30 by the non-slip member 608 being compressed. Also, by pressing the lever 606 upward, the fixed state of the installation apparatus 10d is brought into a released state easily. In this manner, the fixed state and the released state can be switched through one-touch operation.

In this manner, with the configuration having the clamping mechanism in the installation apparatus, mounting and fixing of the installation apparatus is enabled with a simple operation on the desk. Consequently, improvement of the convenience when the projector is used is achieved.

### A6. Sixth Embodiment

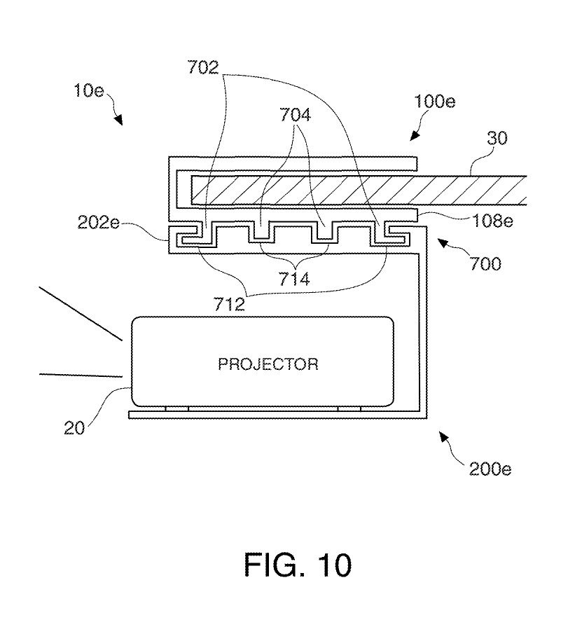

FIG. 10 is an explanatory drawing showing a schematic configuration of an installation apparatus 10e in a sixth embodiment. It has substantially the same configuration as the installation apparatus 10 in the first embodiment and is mainly different therefrom in that a sliding mechanism 700 is provided, and the connecting portion 250 is not provided. The sliding mechanism 700 includes main rails 702, stopper rails 704, main guides 712, and stopper guides 714.

The main rails 702 and the stopper rails 704 are formed on the underside of a first bottom surface member 108e. In contrast, the main guides 712 and the stopper guides 714 are formed on the upperside of a second upper surface member 202e. The main rails 702 each are a substantially L-shaped projection in cross section, and the main guides 712 each are a recess having a cross section extending along the shape of the main rail 702. The main rails 702 and the main guides 712 allow sliding of a second supporting unit 200e while supporting on the underside of a first supporting unit 100e. The stopper rails 704 each are a projection having a rectangular shape in cross section, and the stopper guides 714 each are a recess having a cross section extending along the shape of the stopper rail 704. The stopper rails 704 and the stopper guides 714 limit the range where the second supporting unit 200e slides. The detailed description will be given later.

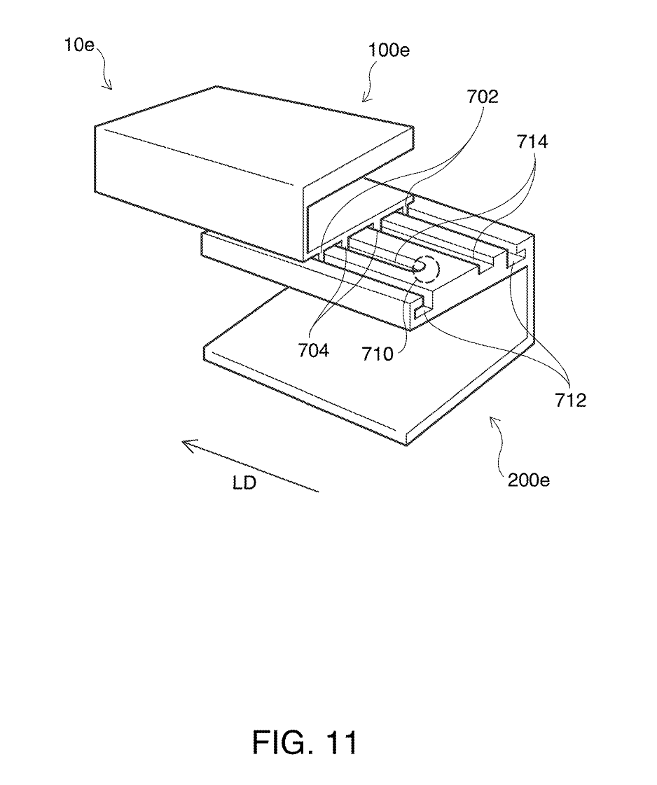

FIG. 11 is an explanatory drawing showing a state in which the second supporting unit 200e is slid by the sliding mechanism 700. One of the stopper guides 714 has a wall portion 710 on the right side. Therefore, when the sliding movement of the second supporting unit 200e in a leftward direction LD can be continued until the stopper rail 704 comes into contact with the wall portion 710. After the stopper rail 704 has come into contact with the wall portion 710, the wall portion 710 prevents the movement and hence the second supporting unit 200e cannot be slid further in the leftward direction LD.

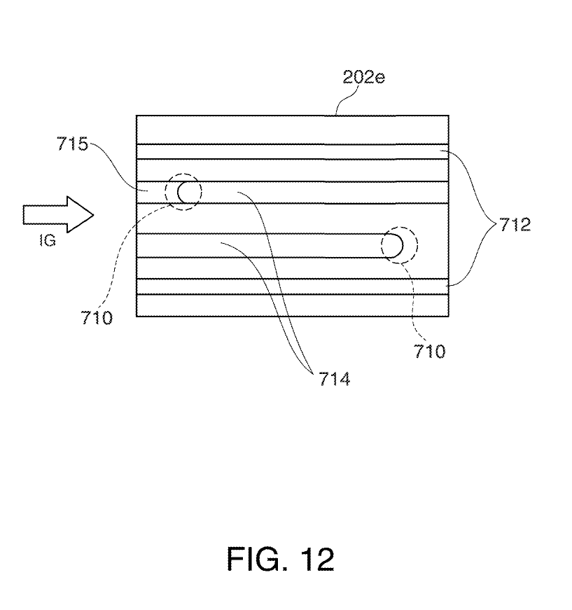

FIG. 12 is an explanatory drawing showing a schematic configuration of an upper surface of the second upper surface member 202e. As shown in FIG. 12, the stopper guides 714 each include the wall portion 710 alternately. One of the wall portions 710 is realized by embedding a detachable stopper member 715 in an end of the recess extending to the end. With the provision of these wall portions 710 at two positions, the sliding movement of the second supporting unit 200e exceeding a certain extent is prevented irrespective of the direction of sliding movement of the second supporting unit 200e between the leftward and rightward directions. When mounting the second supporting unit 200e on the first supporting unit 100e, the stopper member 715 is removed and the main rail 702 and the stopper rail 704 of the first supporting unit 100e are inserted in a direction IG from the side where the stopper member 715 is mounted.

In this manner, with the configuration having the sliding mechanism in the installation apparatus, the lateral adjustment of the projecting position of the projector projecting screen is achieved with a simple operation. Consequently, improvement of the convenience when the projector is used is achieved.

### A7. Seventh Embodiment

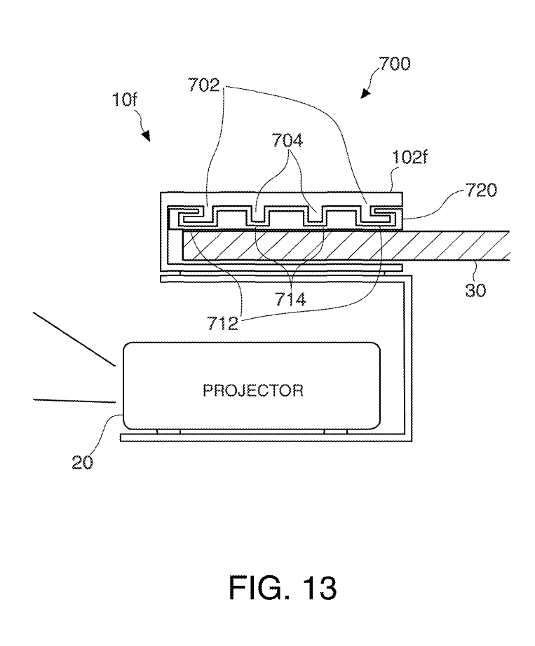

FIG. 13 is an explanatory drawing showing a schematic configuration of an installation apparatus 10f according to a seventh embodiment. It has substantially the same configuration as the installation apparatus 10e in the sixth embodiment shown in FIG. 10 and is mainly different therefrom in that the position where the sliding mechanism 700 is provided is different, and that a desk member 720 is provided. In this embodiment, the main rails 702 and the stopper rails 704 are formed on the underside of a first upper surface member 102f. The main guides 712 and the stopper guides 714 are formed on the upperside of the desk member 720 to be placed on the upperside of the desk 30.

With this configuration as well, improvement of the convenience when the projector is used is achieved as in the sixth embodiment. Furthermore, in the case of the seventh embodiment, since the second supporting unit is supported by the member placed on the upperside of the object to be used for installation, a projector having a heavy weight can be maintained in comparison with the case of the sixth embodiment.

### A8. Eighth Embodiment

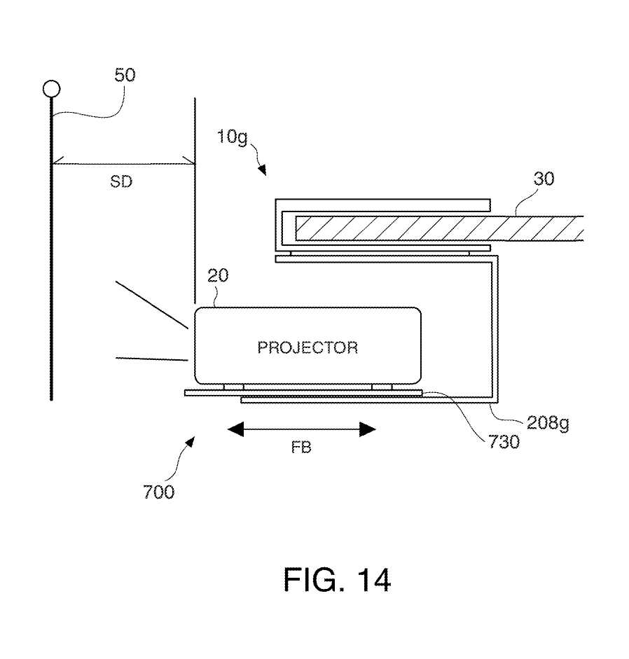

FIG. 14 is an explanatory drawing showing a schematic configuration of an installation apparatus 10g according to an eighth embodiment. It has substantially the same configuration as the installation apparatus 10e in the sixth embodiment shown in FIG. 10 and is mainly different therefrom in that the position and the angle where the sliding mechanism 700 is provided are different, and that a projector supporting member 730 is provided. The projector supporting member 730 is a panel-shaped member for placing the projector 20. In this embodiment, the main rail 702 and the stopper rail 704 are provided on the underside of the projector supporting member 730 in a state of being rotated by 90 degrees in direction. Also, the main guides 712 and the stopper guides 714 are formed on the upperside of a second bottom surface member 208g in the state of being rotated by 90 degrees in direction. In this configuration, the sliding movement of the projector supporting member 730 having the projector 20 placed thereon in a fore-and-aft direction FB. Consequently, adjustment of a distance SD between a screen 50 on the front side and the projector 20 is achieved.

With this configuration as well, improvement of the convenience when the projector is used is achieved as in the sixth embodiment. In the case of the eighth embodiment, adjustment of the distance between the projector and the screen is achieved with a simple operation.

### A9. Ninth Embodiment

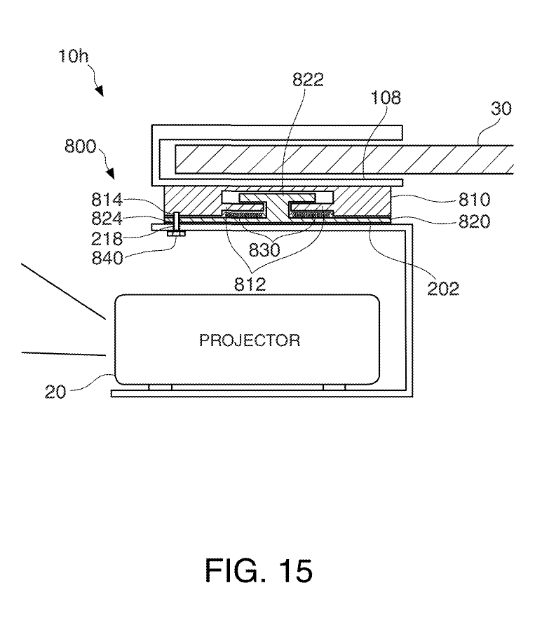

FIG. 15 is an explanatory drawing showing a schematic configuration of an installation apparatus 10h according to a ninth embodiment. FIG. 15 is a cross-sectional view of the installation apparatus 10h. It has substantially the same configuration as the installation apparatus 10 in the first embodiment and is mainly different therefrom in that a rotating mechanism 800 is provided. The rotating mechanism 800 includes a rotation supporting member 810, a rotating unit 820, resilient members 830, and a fixing member 840.

The rotation supporting member 810 is a member configured to support the rotating unit 820, and is arranged on the underside of the first bottom surface member 108. The rotation supporting member 810 includes supporting arms 812 and fixing holes 814. The supporting arms 812 support the rotating unit 820 by being fitted with a rotating bar 822 of the rotating unit 820. The fixing holes 814 are holes for allowing insertion of the fixing member 840. The rotating unit 820 is a member configured to allow the rotation in a state of being supported by the rotation supporting member 810, and is arranged on the second upper surface member 202. The rotating unit 820 includes the rotating bar 822 and a fixing hole 824. The rotating bar 822 is a member having a substantially T-shape in cross section of the projection thereof. The fixing hole 824 is a hole for allowing insertion of the fixing member 840. The resilient members 830 are fixed at one end thereof to the rotation supporting member 810, and at the other end thereof to the rotating unit 820. The fixing member 840 is a member for fixing the rotating unit 820 and the rotation supporting member 810 at a specific position by being penetrated through a fixing hole 218 provided on the second upper surface member 202, the fixing hole 824 of the rotating unit 820, and the fixing holes 814 of the rotation supporting member 810. The fixing member 840 may be, for example, a screw-shaped member.

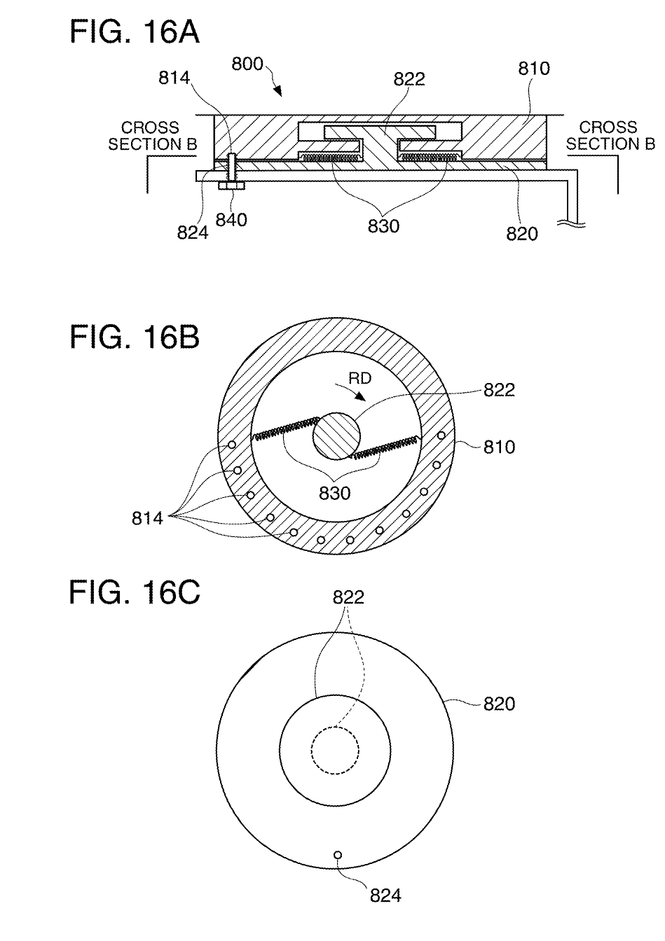

FIGS. 16A, 16B, and 16C are explanatory drawings showing a schematic configuration of the rotating mechanism 800. FIG. 16A is a drawing showing the rotating mechanism 800. FIG. 16B is a drawing showing a cross section B of FIG. 16A. The resilient member 830 is fixed at one end thereof to the rotation supporting member 810, and at the other end thereof to the rotating unit 820. Therefore, when the rotating unit 820 is rotated in a rotating direction RD, a force to return the rotating unit 820 in the opposite direction from the rotating direction RD is exerted by the resilient member 830. Therefore, the fixing member 840 is used for fixing the rotating unit 820 at a given position. FIG. 16C is a drawing of the rotating unit 820 viewed from above. The rotating unit 820 includes one fixing hole 824. In contrast, the rotation supporting member 810 includes the plurality of fixing holes 814 at a regular pitch. Accordingly, fixation of the rotating unit 820 is enabled at a given position where the fixing hole 824 of the rotating unit 820 and one of the fixing holes 814 of the rotation supporting member 810 match. The resilient member 830 may be omitted.

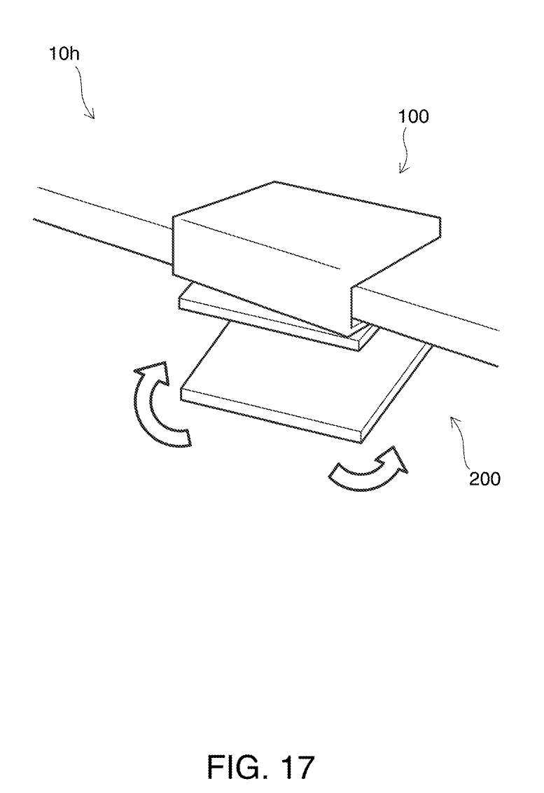

FIG. 17 is an explanatory drawing showing a state in which the second supporting unit 200 is rotated by the rotating mechanism 800. By using the rotating mechanism 800, the user is allowed to rotate the second supporting unit 200 manually leftward and rightward. At this time, the first supporting unit 100 remains to be fixed on the desk 30. Although the rotating mechanism 800 is configured to be operated manually by the user in this embodiment, it may be configured to be operated electrically with a motor or the like.

In this manner, with the configuration having the rotating mechanism in the installation apparatus, the lateral adjustment of the projecting direction of the projector is achieved with a simple operation. Consequently, improvement of the convenience when the projector is used is achieved.

### A10. Tenth Embodiment

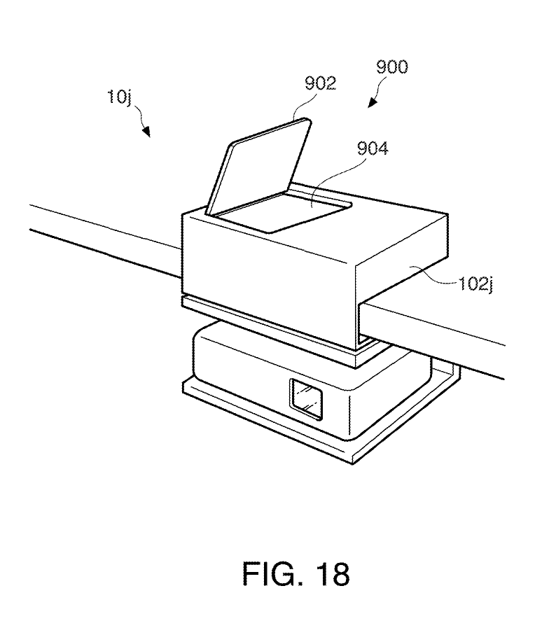

FIG. 18 is an explanatory drawing showing a schematic configuration of an installation apparatus 10j according to a tenth embodiment. It has the same configuration as the installation apparatus 10 in the first embodiment shown in FIG. 1 except that a storing mechanism 900 is provided. The storing mechanism 900 includes a cover 902 and a storage unit 904. The storage unit 904 is a space for storing accessories (for example, a remote control of the projector 20) and is arranged in an upper surface of a first upper surface member 102j. The cover 902 is a lid of the storage unit 904. The cover 902 may be omitted. The position and the shape of the storage unit 904 shown here are no more than examples, and it may be arranged at a given position in a given form.

In this manner, with the configuration provided with the storing mechanism in the installation apparatus, the small peripheral apparatus of the projector or writing tools may be orderly stored and losing of the peripheral apparatuses is restrained. Consequently, improvement of the convenience when the projector is used is achieved.

### A11. Eleventh Embodiment

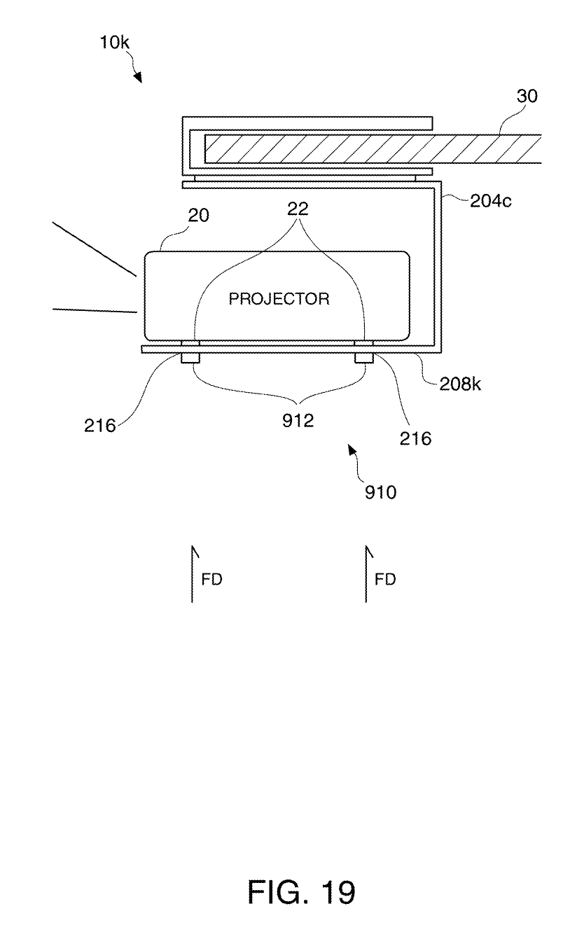

FIG. 19 is an explanatory drawing showing a schematic configuration of an installation apparatus 10k according to an eleventh embodiment. It has substantially the same configuration as the installation apparatus 10 in the first embodiment and is mainly different therefrom in that a fixing mechanism 910 is provided. The fixing mechanism 910 includes fixing members 912. A second bottom surface member 208k includes fixing holes 216. The fixing members 912 are fitted through the fixing holes 216 and hanging holes 22 of the projector 20 from a lower side FD. Accordingly, fixation of the projector 20 to the second bottom surface member 208k of the installation apparatus 10k is achieved. In order to accommodate various projectors, the fixing holes 216 on the second bottom surface member 208k are preferably configured so that the positions of screw holes are adjustable.

In this manner, with the configuration having the fixing mechanism in the installation apparatus, fixation of the projector to the installation apparatus is achieved using the existing hanging holes. Consequently, improvement of the convenience when the projector is used is achieved.

### A12. Twelfth Embodiment

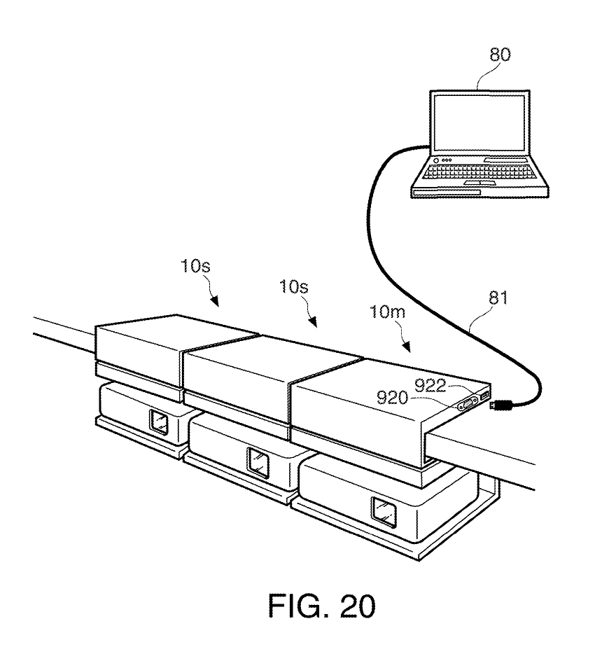

FIG. 20 is an explanatory drawing showing a schematic configuration of an installation apparatus 10m and installation apparatuses 10s according to a twelfth embodiment. It has substantially the same configuration as the installation apparatus 10 in the first embodiment and is mainly different therefrom in that a plurality of installation apparatuses (installation apparatus 10s) can be connected to the installation apparatus 10m. The installation apparatus 10m and the two installation apparatuses 10s are connected in series. From among the three installation apparatuses, the installation apparatus 10m serves as a master apparatus and the installation apparatuses 10s serve as slave apparatuses. The installation apparatus 10m as the master apparatus includes a RGB input interface 920 and an USB interface 922. A USB connector 81 of the computer 80 is connected to the USB interface 922 of the installation apparatus 10m.

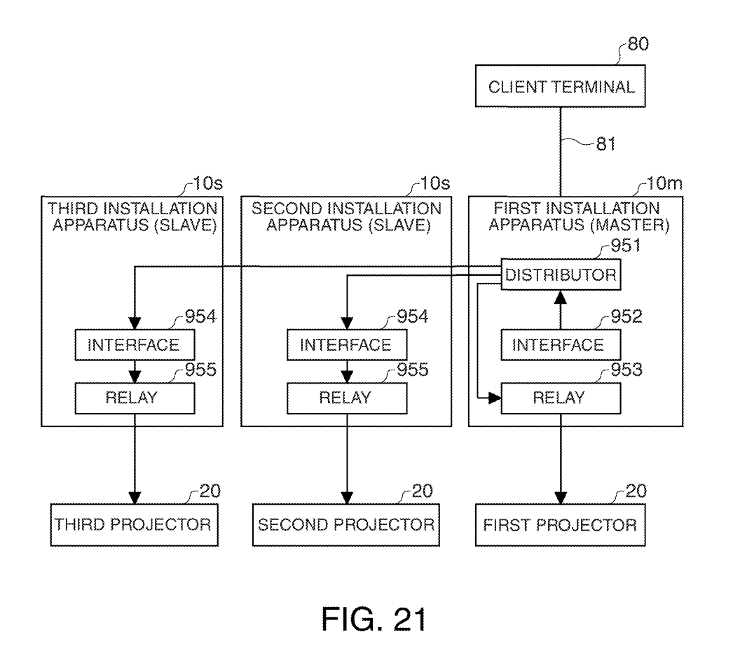

FIG. 21 is a block diagram showing a schematic configuration of the installation apparatus 10m and the installation apparatuses 10s according to the twelfth embodiment. The installation apparatus 10m includes a distributor 951, an interface 952, and a relay 953. The interface 952 is an interface for connecting the installation apparatus 10m to external equipment (such as the computer 80) for acquiring data. The distributor 951 distributes data received from the interface 952 to the respective installation apparatuses. The relay 953 relays the data received from the distributor 951 to the projector connected to the corresponding installation apparatus (that is, the projector 20). The installation apparatuses 10s each include an interface 954 and a relay 955. The interfaces 954 of the installation apparatuses 10s are interfaces for connecting the installation apparatuses 10s to the installation apparatus 10m as the master apparatus for acquiring data. The relays 955 each relay the data received from the interface 954 to the projector connected to the corresponding installation apparatus. Although the installation apparatus 10m as the master apparatus and the installation apparatuses 10s as the slave apparatuses have different configuration in this embodiment, the plurality of installation apparatuses having the same configuration may also be used. In such a case, an arbitrary one of these installation apparatuses corresponds to the master apparatus, and the remaining installation apparatuses correspond to the slave apparatuses.

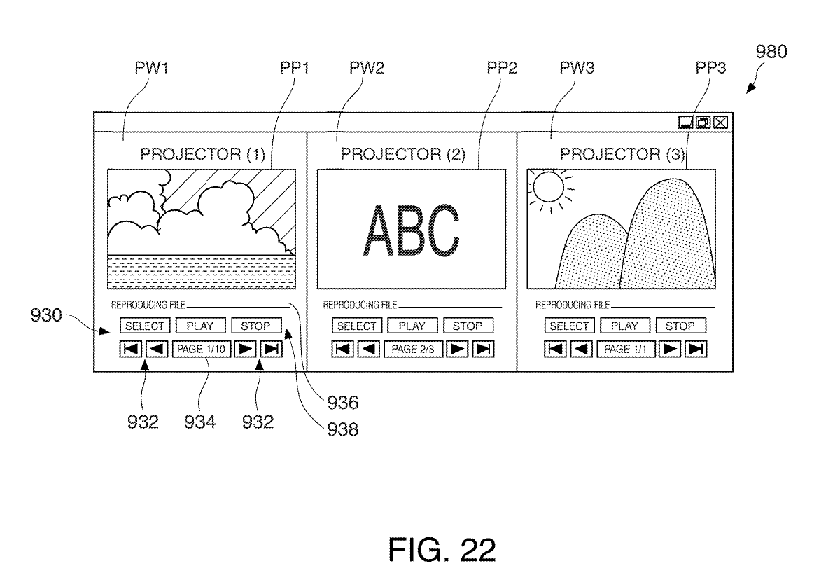

FIG. 22 is an explanatory drawing showing an example of a screen of an application executed by the computer 80. An application 980 is an application for specifying images to be projected by the first to the third projectors 20 respectively. The application 980 includes three windows PW1 to PW3 displayed thereon. The window PW1 corresponds to the first projector. In the same manner, the window PW2 corresponds to the second projector, and the window PW3 corresponds to the third projector. The window PW1 will be described as an example. The window PW1 includes a window PP1 configured to display an image which is to be projected by the first projector, and a display setting unit 930. The display setting unit 930 includes a skip button 932, a page display unit 934, a reproduction file selecting unit 936, and a reproduction stop unit 938. The user selects a file that he or she wants to project by the reproduction file selecting unit 936. Then, by the operation of the reproduction stop unit 938 and the skip button 932, migration in the pages of the corresponding file is achieved. The page display unit 934 shows data indicating the position of the page of the currently displayed image in the file. The number of windows provided in the application 980 is “the number of the installation apparatuses 10s as the slave apparatuses+1”.

In this manner, the user specifies the images to be displayed by the respective projectors by the application 980 on the computer 80. The application 980 adds IDs which indicate the projectors used for displaying images (PP1 to PP3) on the respective images and sends data to the installation apparatus 10m as the master apparatus. The distributor 951 of the installation apparatus 10m distributes data to the respective installation apparatuses on the basis of these IDs. The application 980 is an example of means for displaying different images on the plurality of installation apparatuses, and other means may also be employed. A configuration in which the plurality of projectors 20 are caused to project the same image is also applicable.

In this manner, with the configuration in which the plurality of installation apparatuses are controllable by connecting the same, all the projectors may be caused to project images only by an input to the master installation apparatus, so that flexible usage of the projector according to the application is achieved. Consequently, improvement of the convenience when the projector is used is achieved.

### A13. Thirteenth Embodiment

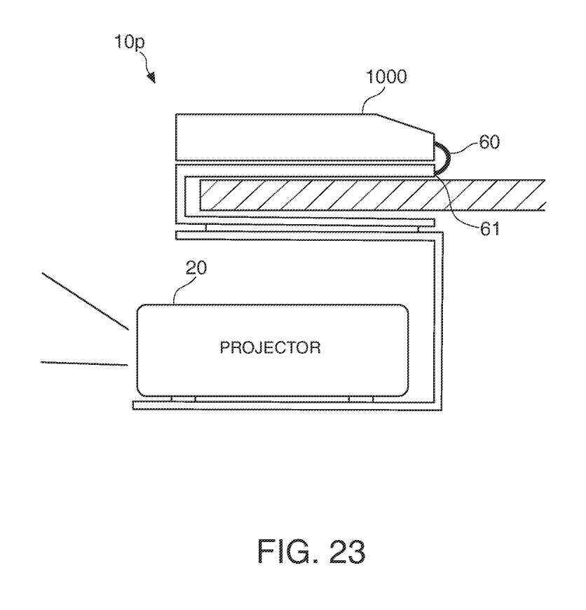

FIG. 23 is an explanatory drawing showing a schematic configuration of an installation apparatus 10p according to a thirteenth embodiment. It has substantially the same configuration as the installation apparatus 10 in the first embodiment and is mainly different therefrom in that a projector support equipment 1000 is provided. The projector support equipment 1000 is connected to a USB interface 62 of the installation apparatus 10p by a USB connector 60. A configuration in which the projector support equipment 1000 and the IF unit 21 of the projector 20 are connected directly is also applicable.

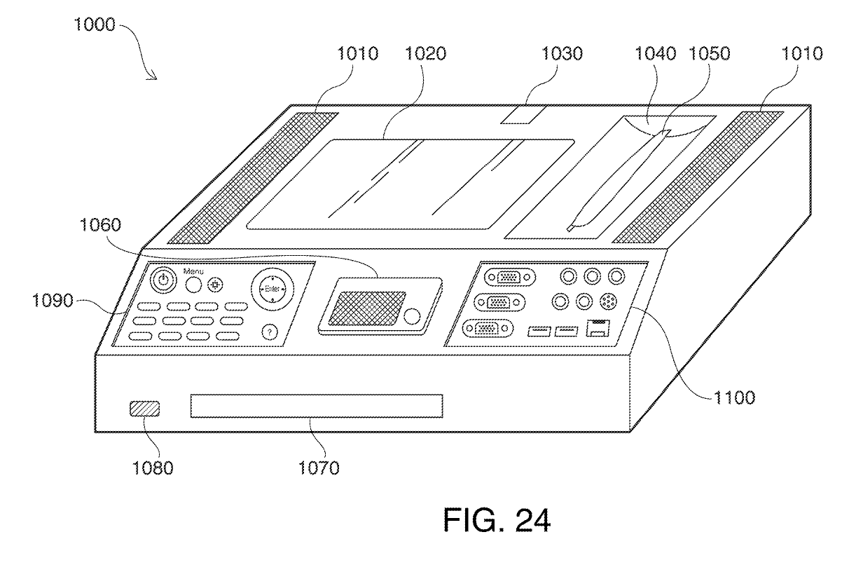

FIG. 24 is an explanatory drawing showing a schematic configuration of the projector support equipment 1000. The projector support equipment 1000 includes a speaker 1010, a display 1020, a camera 1030, a general case 1040, a digital pen 1050, a microphone 1060, a blu-ray Disk Drive 1070, a remote control receiving unit 1080, an operation panel 1090, and a connecting box 1100.

The speaker 1010 is, for example, a speaker which is able to reproduce sounds when projecting a video by the projector 20. The display 1020 is a display which is able to display a screen projected by the projector 20 and is able to display a video shot by the camera 1030. The camera 1030 is a foldable camera which can be stored in the projector support equipment 1000. The camera 1030 is preferably a camera including lenses on the front and rear surfaces thereof, so as to be capable of shooting images on the front and rear, respectively. The general case 1040 is a space in which various small peripheral accessories can be stored. The digital pen 1050 is a pen-type electronic stationary and is capable of storing a handwriting drawn thereby as vector data. The microphone 1060 is a detachable compact microphone and is able not only to reinforce a voice of a person who makes a presentation, but also to record conversations during conferences. The blu-ray Disk Drive 1070 corresponds to a blu-ray Disk, and is a readable and rewritable disk drive. The remote control receiving unit 1080 serves to receive infrared rays from the remote controller of the projector 20. The operation panel 1090 is an operation panel which allows the user to operate the projector 20 in the same manner as with the remote controller. The connecting box 1100 includes a group of interfaces for connecting the projector 20 with various external input devices.

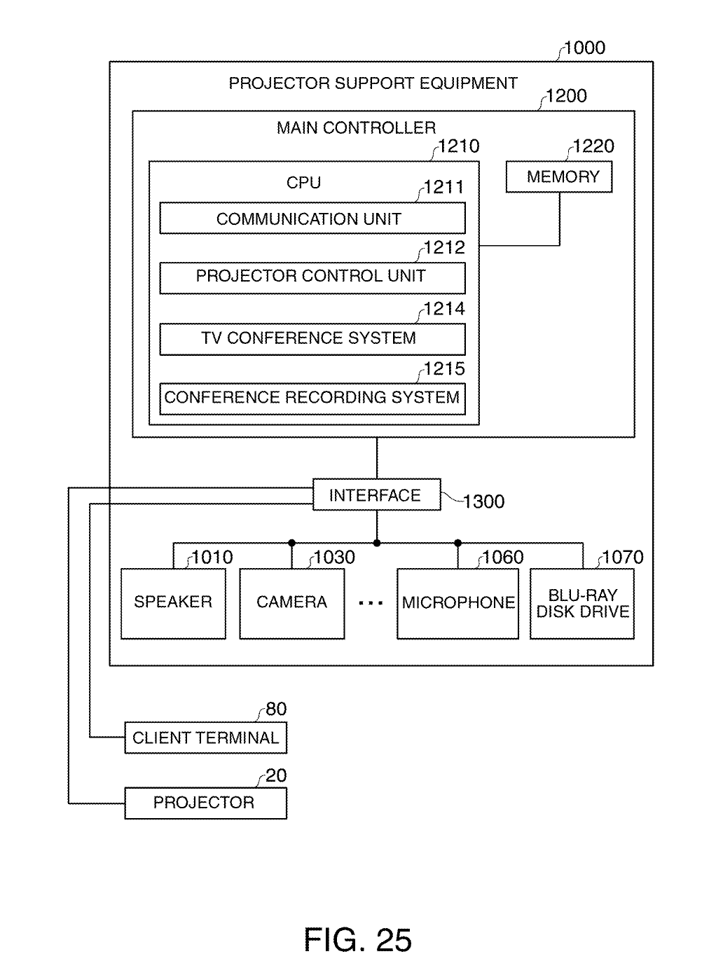

FIG. 25 is a block diagram showing a function of the projector support equipment 1000. The projector support equipment 1000 includes a main controller 1200, an interface 1300, and peripheral devices 1010 to 1100 (hereinafter, referred also to as “peripheral devices”). The interface 1300 is an interface for connecting the main controller 1200, the computer 80 and the projector 20 to be connected externally thereto, and the peripheral devices. The main controller 1200 includes a CPU 1210 and a memory 1220. The CPU 1210 includes a communication unit 1211, a projector control unit 1212, a TV conference system 1214, and a conference recording system 1215. The detailed description of these members will be given later.

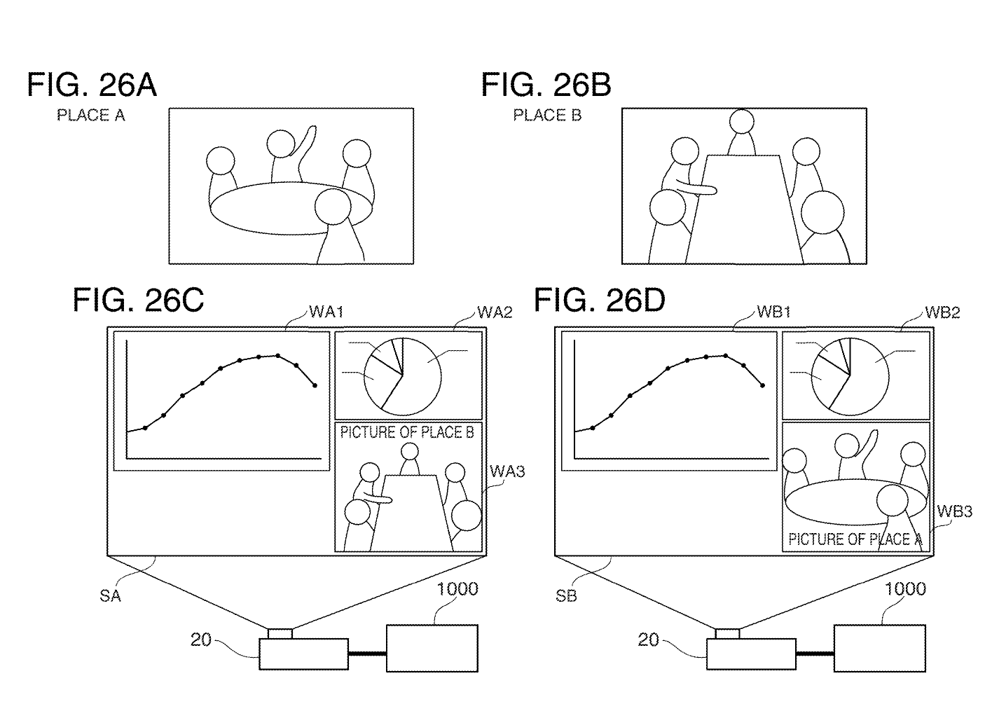

FIGS. 26A to 26D are explanatory drawings showing states of conferences using the installation apparatus 10p. FIG. 26A shows a picture of a conference at a place A. FIG. 26B shows a picture of a conference in a place B at the same time of the day as FIG. 26A. FIG. 26C shows a projecting screen SA of the projector 20 installed at the place A. In the projecting screen SA, a window WA1 which displays a first content (sequential line graph), a window WA2 which displays a second content (pie chart), and a window WA3 displaying the state of the place B. In contrast, FIG. 26D shows a projecting screen SB of the projector 20 installed in the place B. In the projecting screen SB, a screen WB1 which displays a contents similar to the window WA1, a screen WB2 configured to display a content similar to the window WA2, and a screen WB3 configured to display the state at the place A.

The TV conference system 1214 performs control as follows, for example, in cooperation with the communication unit 1211 and the projector control unit 1212. The communication unit 1211 receives data from the camera 1030 and the microphone 1060 of the projector support equipment 1000 installed at the place B. The TV conference system 1214 having received the data from the communication unit 1211 passes synthesized data including a video and sounds to the projector control unit 1212. The projector control unit 1212 having received the synthetic data projects the synthetic data on the predetermined window WA3. The projector control unit 1212 displays specified images also on windows WA1 and WA2. The images displayed on the windows WA1 and WA2 are sent to the projector support equipment 1000 at the place B via the communication unit 1211, so that the same image is commonly viewed in the place B as well. In the same manner, the handwriting drawn by the digital pen 1050 may be displayed commonly as pointers on the projecting screens. The conference recording system 1215 is able to record the projecting screen SA and the sound data at that time using the blu-ray Disk Drive 1070.

In this manner, with the configuration having the projector support equipment in the installation apparatus, the projector and the peripheral devices of the projector support equipment are integrated so as to be used in a wider range of applications. Consequently, improvement of the convenience when the projector is used is achieved.

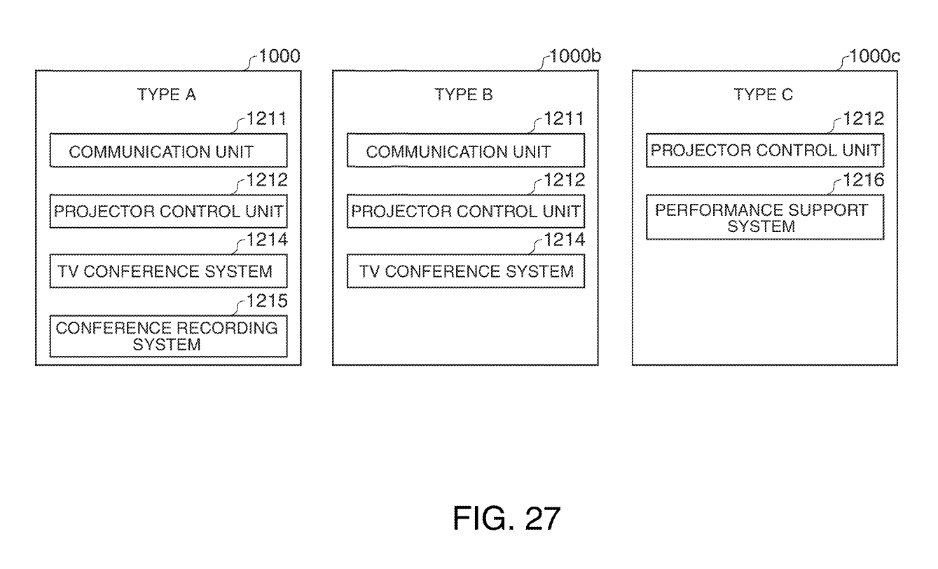

FIG. 27 is a block diagram showing a function of various types of projector support equipment which can be used in the thirteenth embodiment. The installation apparatus 10p allows connection of the projector support equipment arbitrarily selected from a plurality of types according to the application of usage of the projector 20 to be installed. A first projector support equipment 1000 is the same as the projector support equipment 1000 described in FIG. 24. A second projector support equipment 1000b does not have the blu-ray Disk Drive 1070, and hence has a configuration in which the conference recording system 1215 is not included. A third projector support equipment 100c does not have the communication unit 1211 and the blu-ray Disk Drive 1070, and hence has a configuration in which the TV conference system 1214 and the conference recording system 1215 are not included. In contrast, a performance support system 1216 of the (third) projector support equipment 100c is capable of reinforcing the voice of the user inputted, for example, into the microphone 1060 and causes the same to come out from the speaker 1010.

In this manner, with the configuration which allows installation of one of the plurality of types of the projector support equipment arbitrarily selected according to the application of usage of the projector installed in the installation apparatus, various types of the projector support equipment can be used adequately depending on the application of usage or the budget of the projector. Consequently, improvement of the convenience when the projector is used is achieved.

### B. Modifications

The embodiment is not limited to the embodiments described above, and may be implemented in various modes without departing the scope of the disclosure. For example, following modifications are also applicable.

### B1. Modification 1

In the embodiments described above, various installation apparatuses having different functions are listed up. However, all these functions may be provided in a single installation apparatus. A configuration in which one or more functions are combined arbitrarily is also applicable.

### B2. Modification 2

In the embodiments described above, the desk is exemplified as an object to be used for installation. However, this installation apparatus may be installed on arbitrary objects. For example, it may be installed on a shelf.

### B3. Modification 3

In the embodiments described above, the peripheral apparatus provided in the projector support equipment have been exemplified. However, other various peripheral apparatuses may be provided in the projector support equipment. For example, the following peripheral apparatuses may be provided.

cable for connecting external devices such as the projector or the computer.

indicator configured to display the status of the projector or the peripheral apparatuses on the projector support equipment.

device realizing radio communication (for example, Bluetooth, wireless USB, wireless LAN).

hard disk for storing files of the objects to be projected, conference data, or conference note.

sensor having an interactive function.

drive for an external storage medium (for example, CD, DVD, MO).

digital camera.

printer.

scanner.

TV antenna, tuner.

file server installed in each conference room.

What is claimed is:

1. An installation apparatus configured to install a projector comprising:
a first supporting unit having a member to be placed on an object used for installation;
a second supporting unit extending downward of the object from the first supporting unit and supporting the projector under the object; and
a connecting portion having a plurality of connectors configured to connect the projector arranged therein.

2. The installation apparatus according to claim 1, wherein the installation apparatus has a substantially S-shaped cross section.

3. The installation apparatus according to claim 1, wherein the first supporting unit and the second supporting unit are connected by a rotatable first movable member.

4. The installation apparatus according to claim 1, wherein the second supporting unit includes:
a bottom surface member configured to support a lower portion of the projector;
an upper side surface portion extending from the first supporting unit to the bottom surface member,
wherein the bottom surface portion and the upper side surface portion are connected by a second movable member.

5. The installation apparatus according to claim 1, wherein the first supporting unit includes a switching unit configured to switch the state between a fixed state in which the first supporting unit is fixed to the object and a released state in which the first supporting unit is not fixed to the object with one-touch operation.
